(19) United States
(12) Patent Application Publication
(10) Pub. No.: US 2026/0184417 A1
(43) Pub. Date: Jul. 2, 2026

(54) FLUID RESERVOIR, APPARATUSES COMPRISING A FLUID RESERVOIR, AND METHODS COMPRISING A FLUID RESERVOIR

(71) Applicant: The Boeing Company, Arlington, VA (US)

(72) Inventor: Mitchell F. Johnson, Seattle, WA (US)

(21) Appl. No.: 19/003,968

(22) Filed: Dec. 27, 2024

(51) Int. Cl. B64C 3/34; F15D 1/12

(52) U.S. Cl. CPC B64C 3/34; F15D 1/12

(57) ABSTRACT

A fluid reservoir comprises a reservoir body and a passage. The reservoir body is configured to be arranged within an aerodynamic component. The passage is configured to operatively couple the reservoir body to an exterior surface of the aerodynamic component. The passage is further configured to flow fluid from the reservoir body to the exterior surface when a pressure differential exceeds a threshold pressure differential. The threshold pressure differential is a difference between a pressure at a terminal end of the passage and a pressure of an interior of the reservoir body. An apparatus comprises an aerodynamic component and a reservoir. The passage is configured to flow fluid from the reservoir body to the exterior surface when a pressure differential exceeds a threshold pressure differential. A method comprises flowing fluid from a reservoir to an exterior surface of an aerodynamic component at a threshold pressure differential.

### FIELD

The present disclosure relates to a fluid reservoir, apparatuses comprising the fluid reservoir, and methods comprising the fluid reservoir.

### BACKGROUND

During aerodynamic testing, fluid is applied to test surfaces to identify characteristics of airflow over the test surface. In one example, a testing apparatus comprises applicators to apply fluid during testing. However, this method requires a complicated testing apparatus within the aerodynamic testing area. One example of such a testing apparatus is applicators built into a wind tunnel. Another method applies fluid to the test surface prior to the test. However, in this method, the fluid can be displaced while the airflow increases to the desired speed. Thus, accuracy of the test may be reduced. There is a need for further methods to apply a fluid to test surfaces during aerodynamic testing.

### SUMMARY

A fluid reservoir, apparatuses comprising the fluid reservoir, and methods comprising the fluid reservoir are disclosed. In some examples a fluid reservoir comprises a reservoir body and a passage. The reservoir body is configured to hold fluid and to be arranged within an aerodynamic component. The passage is configured to operatively couple the reservoir body to an exterior surface of the aerodynamic component. The passage is further configured to flow fluid from the reservoir body to the exterior surface when a pressure differential exceeds a threshold pressure differential. The threshold pressure differential is a difference between a pressure at a terminal end of the passage and a pressure of an interior of the reservoir body.

An example of an apparatus comprises an aerodynamic component and a fluid reservoir. The reservoir comprises a reservoir body arranged within an interior of the aerodynamic component, and the reservoir is configured to hold fluid. The passage is operatively coupled to an exterior surface of the aerodynamic component, and the passage is configured to flow fluid from the reservoir body to the exterior surface when a pressure differential exceeds a threshold pressure differential. The threshold pressure differential is a difference between a pressure at the exterior surface of the aerodynamic component and a pressure of the interior of the reservoir body.

An example of a method comprises flowing fluid from a reservoir to an exterior surface of an aerodynamic component at a threshold pressure differential. The reservoir comprises a reservoir body arranged within an interior of the aerodynamic component. The threshold pressure differential is a difference between a pressure at the exterior surface of the aerodynamic component and a pressure of the interior of the reservoir body.

### BRIEF DESCRIPTION OF THE DRAWINGS

FIG. 1 is a schematic cross-sectional diagram representing an apparatus comprising a fluid reservoir.

FIG. 2 is a schematic top view diagram representing a portion of a wing comprising orifices.

FIG. 3 is a flowchart schematically representing methods for flowing fluid from a fluid reservoir.

### DESCRIPTION

A fluid reservoir, apparatuses comprising the fluid reservoir, and methods comprising the fluid reservoir are disclosed. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

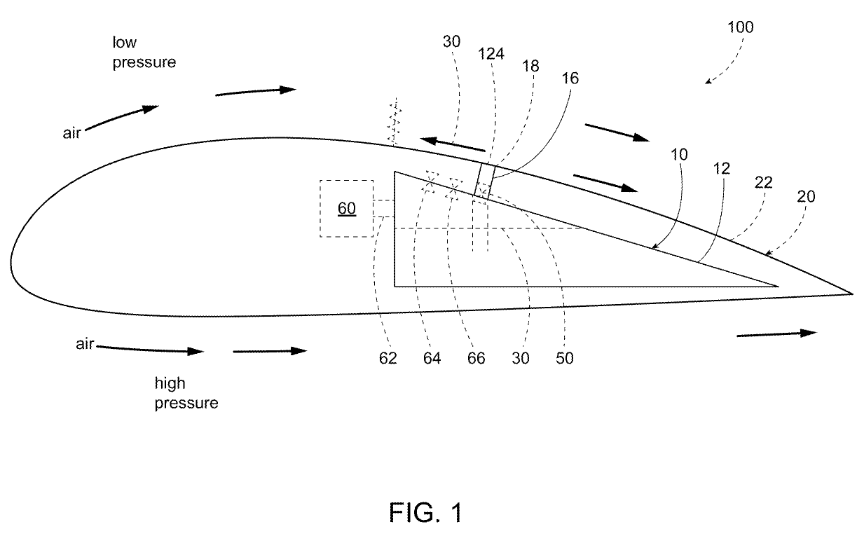

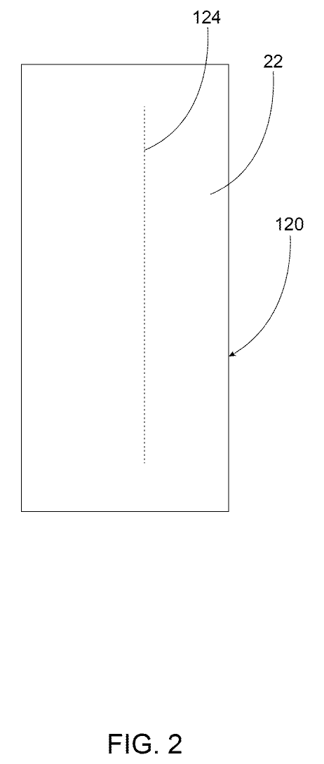

FIG. 2 illustrates a non-exclusive example of the apparatus including a fluid reservoir. Where appropriate, the reference numerals from the schematic illustrations of FIG. 1 are used to designate corresponding parts of the example of FIG. 2; however, the examples of FIG. 2 are non-exclusive and do not limit apparatuses to the illustrated embodiments of FIG. 1. That is, apparatuses are not limited to the specific embodiments of FIG. 2, and apparatuses may incorporate any number of the various aspects, configurations, characteristics, properties, etc. of apparatuses that are illustrated in and discussed with reference to the schematic representations of FIG. 1, as well as variations thereof, without requiring the inclusion of all such aspects, configurations, characteristics, properties, etc. For the purpose of brevity, each previously discussed component, part, portion, aspect, region, etc., or variants thereof may not be discussed, illustrated, and/or labeled again with respect to the examples of FIG. 2; however, it is within the scope of the present disclosure that the previously discussed features, variants, etc. may be utilized with the examples of FIG. 2.

As described in the background section, conventional methods of applying fluid during aerodynamic testing pose challenges. A fluid reservoir is disclosed herein and the fluid reservoir is configured to be arranged within an aerodynamic component. The fluid reservoir is configured to flow fluid to an exterior surface of the aerodynamic component at a threshold pressure differential. Thus, the fluid will not be displaced on the aerodynamic component until the desired testing conditions are reached. Furthermore, the fluid reservoir may be located within the aerodynamic component during testing.

As schematically illustrated in FIG. 1, reservoir 10 comprises reservoir body 12 and passage 16. Reservoir body 12 is configured to be arranged within aerodynamic component 20 and configured to hold fluid 30. Passage 16 is configured to operatively couple reservoir body 12 to exterior surface 22 of aerodynamic component 20. Passage 16 is further configured to flow fluid 30 from reservoir body 12 to exterior surface 22 when a pressure differential exceeds a threshold pressure differential. The threshold pressure differential is a difference between a pressure at terminal end 18 of passage 16 and a pressure of an interior of the reservoir body 12. Thus, reservoir body 12 holds fluid, and passage 16 flows fluid to exterior surface 22 when testing conditions are reached.

Reservoir body 12 may have various configurations depending on aerodynamic component 20 that reservoir body 12 is arranged within. Reservoir body 12 may be shaped to be arranged in a cavity within aerodynamic component 20. In one example, aerodynamic component 20 is wing 120, and reservoir body 12 is arranged in the trailing edge of wing 120. Reservoir body 12 may be comprised of plastic, metal, composites, or other suitable materials for holding fluid. Reservoir body 12 may be hard-sided or soft-sided.

Passage 16 is configured to flow fluid 30 from reservoir body 12 to exterior surface 22. Examples of passage 16 utilize various methods of flowing fluid 30. One example of passage 16 is a conduit comprising a fluid valve 50 configured to flow fluid 30 from reservoir 10 to exterior surface 22 when the pressure differential exceeds a threshold. In one example, fluid valve 50 is a check valve. In a further example, fluid valve 50 is a ball, a diaphragm, a swing, or a butterfly valve.

In other examples, passage 16 utilizes capillary action. In one example, passage 16 has a diameter, and the diameter is configured to create capillary action to flow fluid 30 from reservoir 10 to exterior surface 22 when the pressure differential exceeds a threshold pressure differential. Examples of diameter of passage 16 are configured based on the threshold pressure differential and a viscosity of fluid 30.

Examples of fluid reservoir 10 further comprise components for managing pressure within fluid reservoir 10. In one example, reservoir 10 comprises pressure supply passage 62 configured to receive pressure from a pressure source 60 external to the reservoir 10. Examples of pressure supply passage 62 and pressure source 60 are used to supply pressure to the reservoir 10. Supplying pressure to reservoir 10 can assist in flowing fluid 30 out of reservoir 10 to exterior surface 22. Pressure source 60 may be an active source, such as a fluid pump, or a passive source, such as an area of higher pressure than the pressure at terminal end 18 of passage 16. Pressure source 60 may also be operated at a predetermined threshold, for example, a threshold air speed over aerodynamic component 20.

Further examples of reservoir 10 comprises a vacuum prevention valve 64 configured to flow pressure into the reservoir 10 at a vacuum threshold. Preventing vacuum buildup in the reservoir 10 may prevent failures or faulty operation of passage 16 caused by pressure within the reservoir 10 being too low. For example, low pressure within reservoir 10 may prevent passage 16 from flowing fluid at the desired conditions, because the threshold pressure differential has not been reached due to vacuum accumulation. Examples of vacuum prevention valve 64 are check valves, one-way valves, diaphragms, spring operated valves, full-lift valves, and the like.

Further examples of reservoir 10 comprise a pressure relief valve 66 configured to flow pressure out of the reservoir 10 at a maximum pressure threshold. A pressure relief valve 66 may be used to prevent excessive pressure within the reservoir 10. Excessive pressure could lead to faulty operation or failures, such as rupture of reservoir body 12. Examples of pressure relief valve 66 are check valves, one-way valves, diaphragms, spring operated valves, full-lift valves, and the like. Furthermore, a combination of vacuum pressure and a pressure relief valve in one housing may be used, referred to as pressure vacuum release valve (PVRV).

Apparatuses 100 comprising fluid reservoir 10 are further disclosed. One example of apparatus 100 is schematically shown in FIG. 1. The apparatus 100 of FIG. 1 comprises aerodynamic component 20 and reservoir 10. Reservoir 10 is arranged within an interior of aerodynamic component 20. Passage 16 is operatively coupled to exterior surface 22 of aerodynamic component 20. Examples of passage 16 include a conduit comprising a valve. The pressure at the terminal end of passage 16 is a pressure at the exterior surface 22 of the aerodynamic component 20. In other words, the threshold pressure differential is a difference between a pressure at an orifice 124 and a pressure of an interior of the reservoir body 12. The fluid reservoir 10 of apparatus 100 may be any fluid reservoir 10 disclosed herein.

In one example, the aerodynamic component 20 is a wing 120 or a portion of a wing 120. Examples of wing 120 or portion of a wing 120 are for an airplane, an unmanned aerial vehicle (UAV), or any other aircraft. Examples of wing 120 comprise an entire wing 120 attached to an aircraft, an entire wing 120 detached, or a portion of a wing 120 used for testing. For brevity, portions of a wing 120 may be referred to simply as wing 120 for the purposes of the disclosure. FIG. 2 depicts an example of a portion of a wing 120.

In some examples, wing 120 comprises an orifice 124 in exterior surface 22 of wing 120, and passage 16 is operatively coupled to orifice 124. Examples of wing 120 may also comprise a plurality of orifices 124. The example of FIG. 2 depicts an array of orifices 124 extending down a longitudinal axis of wing 120.

Examples of orifice 124 are arranged on a side of wing 120 that experiences low pressure. The low pressure on this side of wing 120 may be used to draw fluid 30 out of reservoir 10. In some embodiments, pressure supply passage 62 is connected to an area of wing 120 which experiences higher pressure. Such high pressure could be internal or external to wing 120.

In further examples of wing 120, the orifices 124 are the only modifications to an outer mold line of wing 120. In other words, wing 120 does not include modifications to an outer mold line of wing 120 for fluid testing, other than the orifice 124. The lack of modifications to the outer mold line of wing 120 may contribute to increased accuracy of the testing.

Examples of fluid reservoir 10 are arranged in various locations within wing 120. In one example, reservoir 10 is arranged in a trailing edge side of wing 120. In some examples of wing 120, there is a cavity or cavities near the trailing edge side that fluid reservoir 10 may be arranged in without modification to the wing. In further examples, fluid reservoir 10 is arranged between spars of wing 120.

Examples of fluid 30 have a viscosity and a visibility or opacity, useful for aerodynamic testing. In one example, fluid 30 comprises oil and dye. In some examples, the dye is UV-visible. In other examples, fluid 30 is comprised of paint.

The viscosity of fluid 30 influences operation of fluid reservoir 10. In some examples, the diameter of passage 16 is based on the viscosity of fluid 30 and the threshold pressure differential for the passage 16 to create capillary action to flow fluid 30 from reservoir 10 to exterior surface 22 when the pressure differential exceeds the threshold pressure differential. The pressure threshold differential may also be based on the viscosity of the fluid and an airspeed over the aerodynamic component 20. Fluids 30 with higher viscosities may require more force and/or more pressure to move fluid 30.

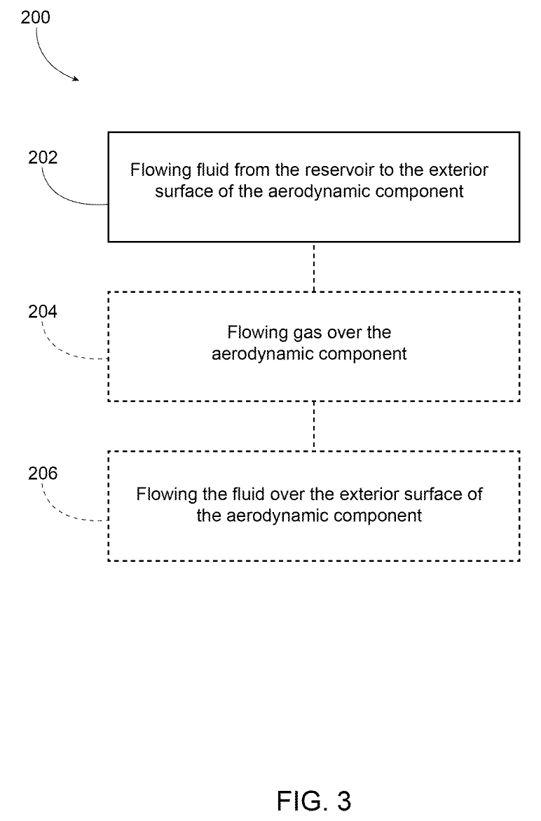

FIG. 3 schematically provides a flowchart that represents illustrative, non-exclusive examples of methods according to the present disclosure. In FIG. 3, some steps are illustrated in dashed boxes, indicating that such steps may be optional or may correspond to an optional version of a method according to the present disclosure. That said, not all methods according to the present disclosure are required to include the step illustrated in solid boxes. The methods and steps illustrated in FIG. 3 are not limiting and other methods and steps are within the scope of the present disclosure, including methods having greater than or fewer than the number of steps illustrated, as understood from the discussions herein.

As seen in FIG. 3, method 200 comprises flowing 202 fluid 30 from reservoir 10 to the exterior surface 22 of the aerodynamic component 20 at the threshold pressure differential. Reservoir 10 may be any reservoir 10 disclosed herein. Examples of method 200 further include aerodynamic component 20 being a wing 120 or a portion of a wing 120. Further examples of method 200 include reservoir 10 being part of apparatus 100, and apparatus 100 being any apparatus disclosed herein.

Further examples of method 200 comprise flowing gas 204 over wing 120 or aerodynamic component 20. Still further examples of method 200 comprise flowing 206 the fluid 30 over exterior surface 22 of the wing 120 or aerodynamic component 20. Examples of flowing gas 204 and flowing fluid 206 may take place simultaneously. In an example of aerodynamic testing of a wing, the flowing gas 204 will provide force to flow 206 the fluid. The fluid 30 on exterior surface 22 of wing 120 is then analyzed to determine how the gas interacted with wing 120.

Shockwaves have a significant impact on aerodynamic performance. As air speed increases, shockwaves form on aerodynamic components 20 and wings 120, which disturb airflow over the surface. An example of a shockwave is schematically shown in FIG. 1. Shockwaves can separate airflow from exterior surface 22 of wing 120.

The presence of a shockwave may pull fluid 30 toward the shockwave in an opposite direction of airflow over a wing 120. In one example, flowing fluid 30 over the exterior surface 22 comprises flowing the fluid 30 from passage 16 towards a shockwave at the exterior surface 22 of the wing 120. In another example, fluid 30 flowing towards the shockwave is flowing in a direction opposite a direction of airflow over the wing 120.

In examples where shockwaves are not present or do not have sufficient force, fluid 30 may be influenced by the airflow over the wing to flow in the direction of the airflow. Examples of flowing the fluid 30 over exterior surface 22 comprise flowing the fluid 30 from passage 16 in the direction of airflow when the shockwave is not present.

Air speed over an aerodynamic component influences pressure at local areas. For example, a typical wing in a conventional configuration will have lower pressure on a top side than on a bottom side. Thus, in some examples of method 200, the threshold pressure differential is based on an air speed over aerodynamic component 20.

Illustrative, non-exclusive examples of inventive subject matter according to the present disclosure are described in the following enumerated paragraphs:

A. A fluid reservoir (10) comprising:

a reservoir body (12) configured to hold fluid (30) and to be arranged within an aerodynamic component (20); and

a passage (16) configured to operatively couple the reservoir body (12) to an exterior surface (22) of the aerodynamic component (20), wherein the passage (16) is configured to flow fluid (30) from the reservoir body (12) to the exterior surface (22) when a pressure differential exceeds a threshold pressure differential, wherein the threshold pressure differential is a difference between a first pressure at a terminal end (18) of the passage (16) and a second pressure of an interior of the reservoir body (12).

A1. The fluid reservoir of paragraph A, wherein the passage (16) comprises a fluid valve (50) configured to flow the fluid (30) from the fluid reservoir (10) to the exterior surface (22) when the pressure differential exceeds the threshold pressure differential.

A1.2. The fluid reservoir of paragraph A1, wherein the fluid valve (50) is a check valve.

A2. The fluid reservoir of paragraph A, wherein the passage (16) has a diameter, and wherein the diameter of the passage (16) is configured to create capillary action to flow the fluid (30) from the fluid reservoir (10) to the exterior surface (22) when the pressure differential exceeds the threshold pressure differential.

A3. The fluid reservoir of any of paragraphs A–A2, wherein the fluid reservoir (10) comprises a pressure supply passage (62) configured to receive pressure from a pressure source (60) external to the fluid reservoir (10).

A4. The fluid reservoir of any of paragraphs A–A3, wherein the fluid reservoir (10) comprises a vacuum prevention valve (64) configured to flow pressure into the fluid reservoir (10) at a vacuum threshold.

A5. The fluid reservoir of any of paragraphs A–A4, wherein the fluid reservoir (10) comprises a pressure relief valve (66) configured to flow pressure out of the fluid reservoir (10) at a maximum pressure threshold.

B. An apparatus (100) comprising:

the aerodynamic component (20);

the fluid reservoir (10) of any of paragraph A–A5, wherein the fluid reservoir (10) is arranged within an interior of the aerodynamic component (20), wherein the passage (16) is operatively coupled to the exterior surface (22) of the aerodynamic component (20), and wherein the first pressure is a pressure at the exterior surface (22) of the aerodynamic component (20).

B1. The apparatus of paragraph B1, wherein the aerodynamic component (20) is a wing (120) or a portion of a wing (120).

B2. The apparatus of any of paragraphs B1, wherein the wing (120) comprises an orifice (124) in the exterior surface (22) of the wing (120), and wherein the passage (16) is operatively coupled to the orifice (124).

B2.1 The apparatus of paragraph B2, wherein the orifice (124) is arranged on a low-pressure side of the wing (120).

B2.2 The apparatus of any of paragraphs B2–B2.2, wherein the wing (120) does not include modifications to an outer mold line of the wing (120) for fluid testing other than the orifice (124).

B2.3 The apparatus of any of paragraphs B2–B2.2, wherein the first pressure is a pressure at the orifice (124).

B3. The apparatus of any of paragraphs B1–B2.3, wherein the fluid reservoir (10) is arranged in a trailing edge side of the wing (120).

B4. The apparatus of any of paragraphs B–B3, wherein the fluid reservoir (10) is configured to receive the fluid (30), and wherein the fluid (30) comprises dye.

B4.1 The apparatus of paragraph B4, wherein the fluid (30) has viscosity, and wherein the passage (16) has a/the diameter, and wherein the diameter of the passage (16) is based on the viscosity of the fluid (30) and the threshold pressure differential for the passage (16) to create capillary action to flow the fluid (30) from the fluid reservoir (10) to the exterior surface (22) when the pressure differential exceeds the threshold pressure differential.

C. A method (200) comprising:

flowing (202) the fluid (30) from the fluid reservoir (10) of any of paragraphs A–A5 to the exterior surface (22) of the aerodynamic component (20) at the threshold pressure differential.

C1. The method (200) of paragraph C, wherein the aerodynamic component (20) is a wing (120) or a portion of a wing (120).

C2. The method (200) of paragraph C1, further comprising flowing gas (204) over the wing (120) or portion of the wing (120).

C3. The method (200) of any of paragraphs C1–C2, further comprising flowing (206) the fluid (30) over the exterior surface (22) of the wing (120) or portion of the wing (120).

C4. The method (200) of any of paragraphs C1–C3, wherein flowing the fluid (30) over the exterior surface (22) comprises flowing the fluid (30) from the passage (16) towards a shockwave at the exterior surface (22) of the wing (120).

C4.1. The method (200) of paragraph C4, wherein the fluid (30) flowing towards the shockwave is flowing in a direction opposite a direction of airflow over the wing (120).

C4.2. The method (200) of any of paragraphs C4–C4.1, wherein flowing the fluid (30) over the exterior surface (22) comprises flowing the fluid (30) from the passage (16) in a/the direction of airflow when the shockwave is not present.

C5. The method (200) of any of paragraphs C4–C4.2, wherein the threshold pressure differential is based on an air speed over the aerodynamic component (20).

C6. The method (200) of any of paragraphs C4–C4.2, wherein the fluid reservoir (10) is part of the apparatus (100) of any of paragraphs B–B4.1.

D. The use of fluid reservoir 10 of any of paragraphs A–A5 for flowing fluid.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A reservoir comprising:
a reservoir body configured to hold fluid and configured to be arranged within an aerodynamic component; and
a passage configured to operatively couple the reservoir body to an exterior surface of the aerodynamic component, wherein the passage is configured to flow fluid from the reservoir body to the exterior surface when a pressure differential exceeds a threshold pressure differential, wherein the threshold pressure differential is a difference between a pressure at a terminal end of the passage and a pressure of an interior of the reservoir body.

2. The reservoir of claim 1, wherein the passage comprises a fluid valve configured to flow the fluid from the reservoir to the exterior surface when the pressure differential exceeds the threshold pressure differential.

3. The reservoir of claim 2, wherein the fluid valve is a check valve.

4. The reservoir of claim 1, wherein the passage has a diameter, and wherein the diameter of the passage is configured to create capillary action to flow the fluid from the reservoir to the exterior surface when the pressure differential exceeds the threshold pressure differential.

5. The reservoir of claim 1, wherein the reservoir comprises a pressure supply passage configured to receive pressure from a pressure source external to the reservoir.

6. The reservoir of claim 1, wherein the reservoir comprises a pressure relief valve configured to flow pressure out of the reservoir at a maximum pressure threshold and/or a vacuum prevention valve configured to flow pressure into the reservoir at a vacuum threshold.

7. An apparatus comprising:
an aerodynamic component;
a reservoir comprising:
a reservoir body arranged within an interior of the aerodynamic component, wherein the reservoir is configured to hold fluid; and
a passage operatively coupled to an exterior surface of the aerodynamic component, and wherein the passage is configured to flow fluid from the reservoir body to the exterior surface when a pressure differential exceeds a threshold pressure differential, wherein the threshold pressure differential is a difference between a first pressure at the exterior surface of the aerodynamic component and a second pressure of the interior of the reservoir body.

8. The apparatus of claim 7, wherein the aerodynamic component is at least a portion of a wing.

9. The apparatus of claim 8, wherein the portion of the wing comprises an orifice in the exterior surface of the portion of the wing, and wherein the passage is operatively coupled to the orifice.

10. The apparatus of claim 9, wherein the orifice is arranged on a low-pressure side of the portion of the wing.

11. The apparatus of claim 9, wherein the portion of the wing does not include modifications to an outer mold line of the portion of the wing for fluid testing other than the orifice.

12. The apparatus of claim 9, wherein the first pressure is a pressure at the orifice.

13. The apparatus of claim 8, wherein the reservoir is arranged in a trailing edge side of the portion of the wing.

14. The apparatus of claim 7, wherein the reservoir is configured to receive the fluid, and wherein the fluid comprises dye.

15. A method comprising:
flowing fluid from a reservoir to an exterior surface of an aerodynamic component at a threshold pressure differential, wherein the reservoir comprises a reservoir body arranged within an interior of the aerodynamic component, and wherein the threshold pressure differential is a difference between a first pressure at the exterior surface of the aerodynamic component and a second pressure of an interior of the reservoir body.

16. The method of claim 15, wherein the aerodynamic component is at least a portion of a wing.

17. The method of claim 16, further comprising flowing gas over the portion of the wing and
flowing the fluid over the exterior surface of the portion of the wing.

18. The method of claim 17, wherein flowing the fluid over the exterior surface comprises flowing the fluid from an orifice in the portion of the wing towards a shockwave at the exterior surface of the portion of the wing.

19. The method of claim 18, wherein the fluid flowing towards the shockwave is flowing in a direction opposite a direction of airflow over the portion of the wing.

20. The method of claim 15, wherein the threshold pressure differential is based on an air speed over the aerodynamic component.
